(19) United States
(12) Patent Application Publication
(10) Pub. No.: US 2005/0017977 A1
(43) Pub. Date: Jan. 27, 2005

(54) Method and apparatus for integrating virtual environments with functional simulations via HLA protocol

(76) Inventors: John J. Simpson, St. Louis, MO (US); Glen Allen Pfeifer, St. Charles, MO (US); Steven Douglas Swaine, St. Charles, MO (US); Raymond Howard Heininger, St. Peters, MO (US); Timothy Stumpf, St. Charles, MO (US)

Correspondence Address: THOMPSON COBURN, LLP, ONE US BANK PLAZA, SUITE 3500, ST LOUIS, MO, 63101, US

(21) Appl. No.: 10/627,570

(22) Filed: Jul. 24, 2003

(51) Int. Cl. G06T 15/70; G06T 17/00

(52) U.S. Cl. 345/473; 345/474; 345/420

(57) ABSTRACT

A method of simulating the behavior of a user-interactive environment, the method comprising: (a) running a virtual environment (VE) simulation application that (1) graphically depicts a VE, (2) receives input from a user that corresponds to a user interaction with the VE, and (3) provides graphical output to the user that corresponds to a condition of the VE; (b) running a functional simulation application that determines the condition for the VE at least in part based upon the user input; (c) communicating the user input received by the VE simulation application to the functional simulation application via a high level architecture (HLA) protocol; and (d) communicating the condition determined by the functional simulation application to the VE simulation application via the HLA protocol.

### FIELD OF THE INVENTION

The present invention relates to improved software simulation systems.

### BACKGROUND AND SUMMARY OF THE INVENTION

Commercial software applications now exist that allow users to create highly realistic computer-generated 3D virtual environments. Some of these virtual environment applications are interactive in that they include realistic functional characteristics or logic-based behaviors with which a person can interact. For example, a 3D virtual environment may be designed that graphically depicts a lamp in a room. The room may have a switch on the wall that corresponds logically with the lamp. A user interaction that moves the switch to an “on” position causes a change in the virtual environment to accommodate the lamp's illumination. A user interaction that moves the switch to an “off” position causes a change in the virtual environment to accommodate no light coming from the lamp.

Using current virtual environment applications, a simple system such as the above lamp example can be conventionally implemented such that both the trigger (switch status) and the end effect (lamp illumination/non-illumination) are hard-coded into the script that defines the environment. However, it is impractical to use such scripting within the virtual environment simulation with applications that simulate highly complex real world systems because the number of triggers and their relationships with trigger-dependent effects are too numerous and complicated. For example, simulating an aircraft control panel using a virtual environment with scripts within the 3D visualization software that accurately simulate the end effects of various gauges on the control panel (which may well be dependent on hundreds of trigger conditions) is virtually impossible to efficiently implement. Such applications that use hard-coded scripts are not designed with the capability to efficiently code or maintain complex run-time system simulations.

Conventionally, to simulate such complex systems, computer-generated virtual 3D environments are not used. Instead, the functional simulator for the complex system is interfaced with a physical hardware mock-up for the system being simulated. Returning to the aircraft control panel example, a mock-up of the aircraft control panel is constructed with the panel's input/output devices being interfaced with the functional simulator. Using input from the physical hardware interface, the functional simulator is able to operate. However, because of the need for a physical hardware user interface, these systems can be very expensive and possess little flexibility in adjusting to changes in the actual interface the user would experience. That is, as time goes on and features are added to an aircraft control panel, the simulation system would require physical alterations to each of the hardware mock-ups in operation; a task which may be very expensive.

In an effort to reduce the cost of complex system simulators and improve the flexibility of such systems, the inventors herein have replaced the physical hardware interface with a computer-generated interactive virtual environment. The virtual environment simulation provides the user with a means to manipulate and visualize the current state of the functional simulation without the need of a physical hardware mock-up. For such a system to operate efficiently, the inventors herein propose interfacing a virtual environment simulation application with a functional simulation application via a runtime infrastructure (RTI) interface that communicates data between the two simulation applications according to the high level architecture (HLA) protocol. To achieve such an integration of the environment visualization software and the functional simulation software, the HLA protocol-based RTI interface preferably can interpret applications written not only by different organizations, but also written in different coding languages, thereby providing the flexibility and power needed for achieving widespread commercial acceptance. Preferably, the HLA protocol follows the Department of Defense (DoD) standard HLA protocol.

Through the RTI interface, the independent but interoperating simulations (the virtual environment simulation and the functional simulation) communicate with each other via objects that are published and subscribed there between. Preferably, the RTI interface includes an application program interface (API) plug-in module for this purpose. Thus, the present invention provides the ability to communicate with or affect a virtual environment from an external functional simulation through a standard interface.

According to one aspect of the present invention, disclosed herein is a method of simulating the behavior of a user-interactive environment, the method comprising: (a) running a virtual environment (VE) simulation application that (1) graphically depicts a VE, (2) receives input from a user that corresponds to a user interaction with the VE, and (3) provides graphical output to the user that corresponds to a condition of the VE; (b) running a functional simulation application that determines the condition for the VE at least in part based upon the user input; (c) communicating the user input received by the VE simulation application to the functional simulation application via a high level architecture (HLA) protocol; and (d) communicating the condition determined by the functional simulation application to the VE simulation application via the HLA protocol.

According to another aspect of the present invention, also disclosed herein is an apparatus for interfacing software configured to graphically depict a three-dimensional user-interactive virtual environment (VE) with software configured to functionally simulate an application associated with the VE, the apparatus comprising: (a) a library of HLA objects that correspond to a state of the VE that is dependent at least in part on user interaction with the VE; and (b) a processor configured to (1) publish via RTI messaging at least one HLA object to the functional simulation software according to the HLA protocol, (2) subscribe via RTI messaging to at least one HLA object published by the functional simulation software according to the HLA protocol, wherein the subscribed HLA object defines at least in part a subsequent state for the VE, and (3) provide data derived from the subscribed HLA object to the VE software for processing thereby.

The present invention can be implemented through computer executable instructions on any suitable computer-readable medium including but not limited to a compact disc (CD), a computer hard drive, network-accessible server, or any other known storage device capable of storing executable programming code.

These and other features and advantages of the present invention will be in part pointed out and in part apparent upon review of the following description, figures, and claims.

### BRIEF DESCRIPTION OF THE DRAWINGS

FIG. 1 is a block diagram overview of a preferred embodiment of the present invention;

FIG. 2 is a block diagram the operation of the API plug-in module in greater detail; and

FIG. 3 is a flowchart illustrating the processing performed by the virtual environment simulation application during a simulation session.

### DETAILED DESCRIPTION OF THE PREFERRED EMBODIMENT

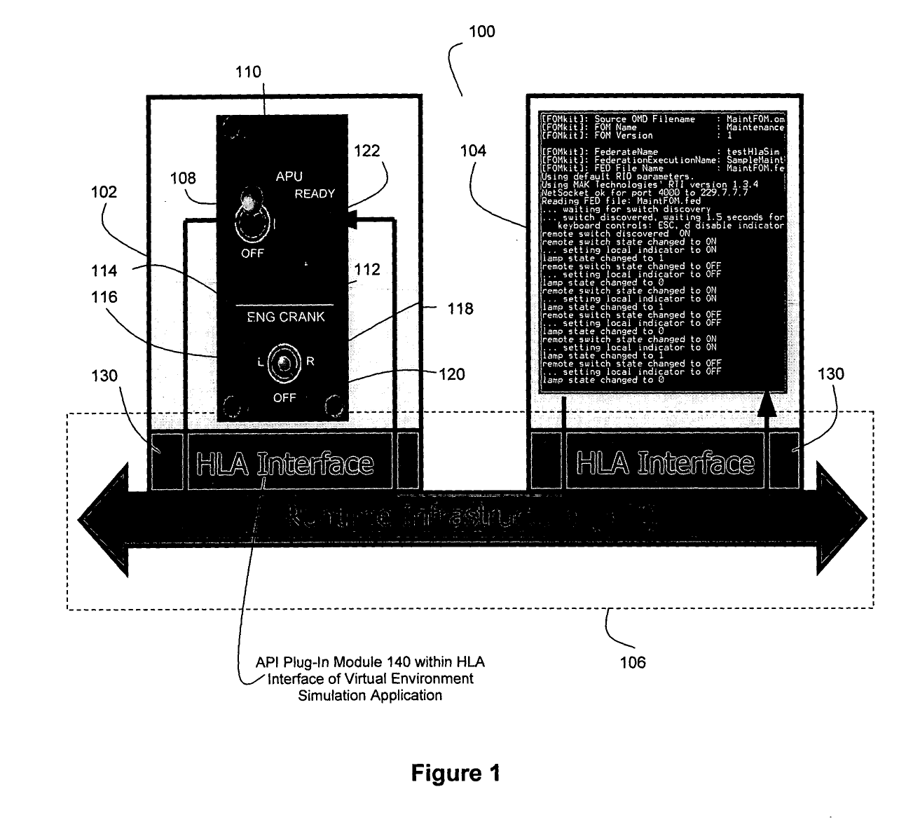

FIG. 1 is a block diagram overview of a preferred embodiment of the present invention. The simulation system 100 comprises a user-interactive virtual environment (VE) simulation application 102, a functional simulation application 104, and a runtime infrastructure (RTI) interface 106 that manages communications between the VE simulation application 102 and the functional simulation application 104.

The VE simulation application 102 graphically depicts an environment with which a user of the system 100 can interact. Preferably, this environment is graphically depicted as a three-dimensional (3D) environment. Examples of preferred 3D environments for the present invention include: aircraft and their maintenance environments, including crew station control panels, avionics, electrical connectors, avionics and other system components that visually or audibly convey status, and test equipment. Other 3D environments to which this invention might apply would be any complex system or vehicle requiring simulation for maintenance training, including reusable manned spacecraft, submarines, large water vessels, and the like. The VE simulation application is preferably implemented on a desktop personal computer (PC). Preferably, such a PC is properly equipped and configured for a network interface, standard user inputs, and high-end 3D graphics computation and display. Additionally, the invention could be implemented on PC equipment properly configured to support immersive VR and related components, such as the associated head-mount display and cyber glove interface devices used therefor.

As the creation and design of 3D interactive virtual environments are well known in the art, further elaboration upon their inner details are not necessary in setting forth the present invention. However, it should be noted that user interactions with the virtual environment (such as, with reference to FIG. 1, flipping APU switch 108 to either the “on” position 110 or “off” position 112, or flipping the engine crank switch 114 to either the “L” position 116, “R” position 118, or “off” position 120) are triggers that signal a user input. This user input is used to determine any state changes that are necessary for the virtual environment to indicate back to the user (such as, for example, whether the “ready” light 122 should be illuminated).

The functional simulation application 104 operates to model the behavior of the system being emulated by simulator system 100. The operation of the functional simulation application 104 for a given end use of the present invention is also known in the art, and as such, no particular functional simulation application is preferred by the inventors. Functional simulation applications are typically realized with real time software development technologies, which currently use C, C++ programs to model functionality such as vehicle functionality in a flight simulation. These programs can be derived using routine skills in the art from existing operational flight program software, test or support equipment software, and the associated engineering design process.

The functional simulator 104 determines the state of the simulation at any moment in time as a function of the user input obtained by the virtual environment simulation application 102 and a programmed behavioral model for the system. The 3D graphical depiction within the virtual environment simulation application 102 is likewise a function of the simulation state determined by the functional simulator 104. The functional simulator 104 is preferably implemented on a desktop personal computer (PC) that is preferably properly equipped and configured with a network interface and located within the LAN on which the virtual environment simulation resides.

The improvement of the preferred embodiment of the present invention resides in part in the integration of these two independent but interoperating applications. According to the present invention, communications between the two applications are managed by the RTI interface 106. RTI interface 106 communicates data between the applications 102 and 104 (referred to as federates, with the system 100 being a federation) via the High Level Architecture (HLA) protocol. An HLA interface 130 interfaces each application with the RTI messaging.

The HLA protocol is a well-known general purpose architecture for simulation reuse and interoperability developed under the leadership of the Department of Defense (DoD). RTI software, whose development was also sponsored by the DoD, is used to support operations of system (federation) execution. The RTI interface provides a set of services used by applications/federates within the system/federation to coordinate their operations and data exchanges during a runtime execution. Access to the set of RTI services is defined according to the HLA protocol. Under HLA guidelines, the state of an object is published and subscribed between applications/federates using RTI. As used herein, the term “object” is defined, where appropriate, in accordance with its ordinary meaning within object-oriented programming, and the objects of primary interest are the HLA objects that are defined to allow communication of the changing value information for the variable called “state”. Each object is created early in the start-up processing of the VE simulation, and, once the corresponding discovery of their existence in the functional simulation is confirmed, is monitored for state variable changes that result in triggered behaviors in the VE.

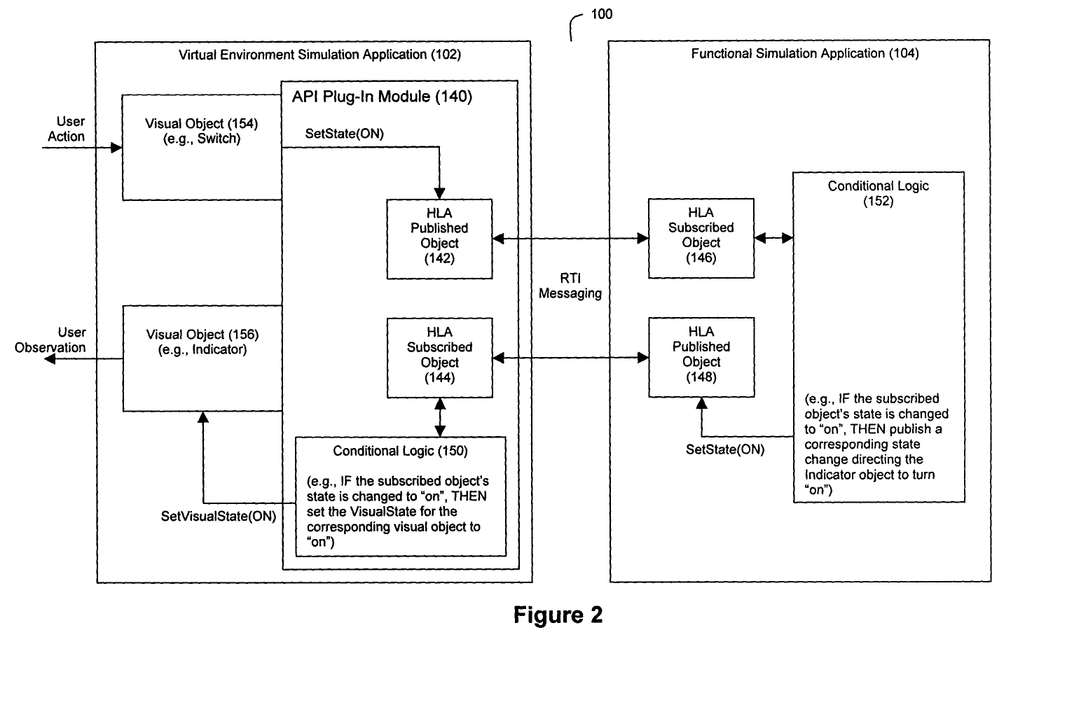

According to the present invention, an application program interface (API) plug-in module 140 is created for the purpose of initiating and maintaining communications between applications 102 and 104 via the HLA-based RTI interface 106. The plug-in module 140, which is preferably implemented within the HLA interface 130 on the virtual environment (VE) side of the system 100 as shown in FIG. 2, dynamically links methods supporting the HLA functionality that are developed using the virtual simulation API into the virtual simulation execution.

The API module 140 is preferably an implementation of a software design concept in which (1) HLA objects can be linked into a virtual simulation such that a remote functional simulation can control visual states the of objects in the local simulation and (2) all objects share state information communicated accordingly through the HLA protocol. The API module preferably includes a library of HLA objects for this purpose.

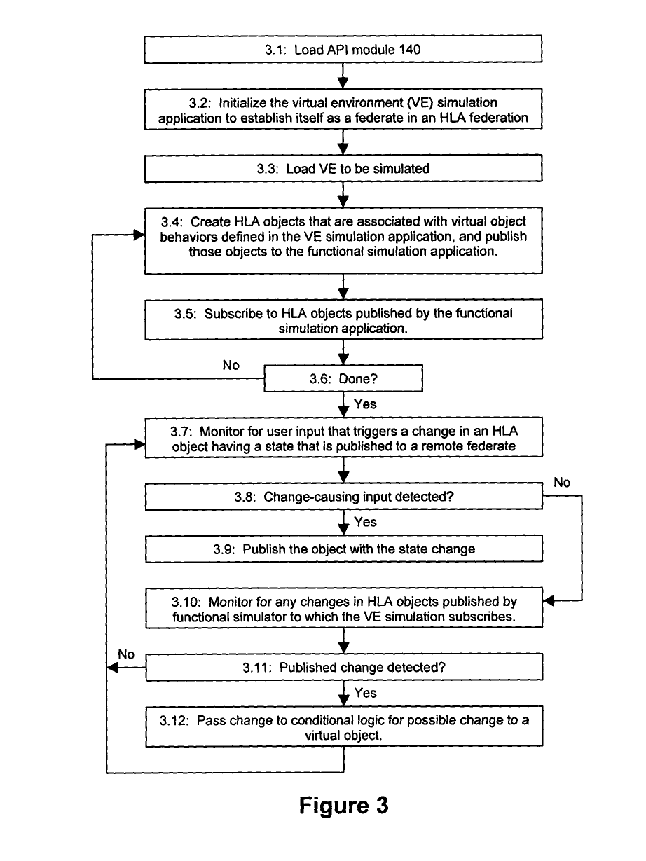

With reference to FIGS. 2 and 3, the virtual simulation software loads the API module (step 3.1 in FIG. 3), and performs a one-time initialization, establishing itself as a federate in the desired HLA federation prior to loading the specific 3D environment being simulated (step 3.2). As the 3D graphics objects are created, loaded and displayed in the virtual simulation (step 3.3), HLA objects are created and associated with visual object behaviors defined in the virtual simulation that the authors have specified (step 3.4). These associations are preferably created by referencing the update functions of the plug-in module with parameters such as the name of the HLA object targeted for an update and the appropriate state to which the targeted HLA object should be set.

Generalizations necessary in the subscribed and published objects can be efficiently characterized using the Object Model Development Tool (OMDT) that is known in the art. The use of OMDT results in minimal software development to facilitate visual simulation authoring. For example, from a large set of data types available in OMDT, a small set of data types can be chosen by a practitioner of the invention that is specifically suited to the general design requirements of the integration of the VE and functional simulations. Thus, two general aircraft cockpit simulation classes might be described using OMDT as simply “switch” and “indicator” classes with possible states being limited to ON and OFF for both. With OMDT, a naming or ID convention can also be chosen to satisfy overall system design requirements for uniquely identifying specific switch and indicator object instances within the system. With such an object model, source code builds and compiler code builds can be generated to produce a single re-usable plug-in that is generalized and valuable for use in many simulators.

This aspect of the invention diminishes or eliminates for recompilation of the API plug-in module for various VE simulators, and further allows for the definition and identification of HLA objects during VE simulation authoring to be synchronized to a specific functional simulation's objects through simple text-naming discipline. The HLA classes defined through OMDT become the common data structure bridging any data type differences that may exist between the VE simulation and the functional simulation. Thus, the API plug-in module can be re-usable for different VE simulation applications if the library of HLA object supported by the module is sufficient to cover the different VE simulation applications. While it is possible that the API plug-in module can also be re-usable for different functional simulation applications, it is expected that each functional simulation application will use its own associated API plug-in module within the VE simulation application, although this need not necessarily be the case.

As the existence of the HLA objects of interest in the remote functional simulation are discovered, the local behaviors dependent on these objects are enabled to thereby subscribe the object to any state changes that are published by the functional simulation side of the system (step 3.5).

With initialization complete, the VE simulation application 102 monitors for user actions that trigger a change in the state of HLA objects published to remote federates (step 3.7). FIG. 2 illustrates an example of this aspect of the system, wherein the API plug-in module 140 publishes object 142 and subscribes to object 144, and wherein the functional simulation application 104 subscribes to object 146 and publishes object 148.

HLA object 142 corresponds to the state of visual object 154, which in this case is a switch. Depending upon the user action that the switch visual object 154 receives as an input through the VE, a SetState( ) command will set the state of object 142 to ON or OFF. Thus, if the user action indicates that the switch is to be turned on, the SetState(ON) command results in the state of object 142 being set to ON. This state is published, and through RTI messaging, the corresponding subscribed object 146 of the functional simulation application 104 learns of the ON state of the switch. Through the state of object 146, conditional logic 152 of the functional simulation application 104 determines, according to the programmed behavior of the system, whether a change is needed to the state of the system as a result of the user action-determined state of visual object 154.

For example, if there is a virtual indicator LED associated with the virtual switch in the VE, the VE simulation application 102 will include a visual object 156 for such an indicator. As a result of the user action indicating that the switch was turned on, the state of the corresponding indicator object 156 will also need to be set to ON to create an illuminated indicator LED within the VE. To accomplish this, conditional logic 152 reacts to the received input from object 146 to provide a SetState(ON) command to published object 148. The subscribed object 144 of the API plug-in module 140 learns of this state through RTI messaging, and further passes this state to conditional logic 150. Conditional logic 150 determines the state change(s) (if any) that are needed in the VE as a result of the publication by the functional simulation application 104. In this example, because the state of the switch was set to ON, the conditional logic 150 sets the state of the indicator object 156 to ON via the SetVisualState(ON) command, which results in the illumination of the virtual indicator corresponding to the visual object 156 within the VE.

Therefore, a user interaction with the VE results in a corresponding change in the VE's state as a result of HLA-based communications with a functional simulation application 104, as shown in FIG. 2 and described in steps 3.7 through 3.12 of FIG. 3.

A summary of software development requirements that characterize a preferred implementation of the API plug-in module are as follows:
The software development process should provide functionality through a user interface that is conveniently presented with a 3D visual simulation application;
The software development process should provide creation of one or more unique HLA objects with a state (e.g., “on” or “off”, etc.) that is controlled by the user interface within the 3D visual simulation. The state of these objects should be published to the functional simulation application, and should be identifiable by the same unique name in each simulation;
The software development process should provide the functionality of setting the states of all published objects upon events that are triggered within the 3D visual simulation;
The software development process should provide creation of one or more unique HLA objects with states that are controlled by the functional simulation. The state of these objects are subscribed to and from the functional simulation application, and must be identifiable by the same unique name in each simulation; and
The software development process should provide for the virtual environment simulation application to catch the state changes of subscribed HLA objects, and thus trigger or influence changes of behavior within the graphically-depicted 3D virtual environment.

While the present invention has been described above in relation to its preferred embodiment, various modifications may be made thereto that still fall within the invention's scope, as would be recognized by those of ordinary skill in the art upon review of the teachings herein.

For example, while FIG. 1 shows a single functional simulator 104 within system 100, it should be noted that a plurality of functional simulators 104 may be included within the system 100, each modeling a different aspect of the system's behavior and communicating with other federates within the system 100 via the HLA protocol-based RTI interface.

Further, federates can be hosted on processors located remotely from each other. Functional simulations are preferably located within the LAN on which the VE simulation application resides. However, it should be noted that the functional simulation application can also communicate with the VE simulation application over the Internet. While typical firewall issues currently exist that discourage such an implementation, future developments with firewall technology and/or improvements in communication latency may render such an implementation highly desirable.

As such, the full scope of the present invention is to be defined solely by the appended claims and their legal equivalents.

1. A method of simulating the behavior of a user-interactive environment, the method comprising:
running a virtual environment (VE) simulation application that (1) graphically depicts a VE, (2) receives input from a user that corresponds to a user interaction with the VE, and (3) provides graphical output to the user that corresponds to a condition of the VE;
running a functional simulation application that determines the condition for the VE at least in part based upon the user input;
communicating the user input received by the VE simulation application to the functional simulation application via a high level architecture (HLA) protocol; and
communicating the condition determined by the functional simulation application to the VE simulation application via the HLA protocol.

2. The method of claim 1 wherein the VE is a three-dimensional VE, and further comprising managing the two communicating steps with a runtime infrastructure (RTI) interface.

3. The method of claim 2 wherein the user input communicating step comprises publishing via an API module at least one HLA object to the functional simulation application, wherein the published HLA object is at least in part defined by the received user input.

4. The method of claim 3 wherein the user input communicating step comprises subscribing to the HLA object published by the API module, and wherein the functional simulation application running step comprises processing the subscribed HLA object through conditional logic to determine the condition for the VE.

5. The method of claim 4 wherein the condition communicating step comprises:
publishing, by the functional simulation application, an HLA object that corresponds to the determined VE condition; and
subscribing, by the API module, to the HLA object published by the functional simulation application.

6. The method of claim 5 wherein the VE simulation application running step comprises determining the graphical output for the VE based on the subscribed HLA object published by the functional simulation application.

7. The method of claim 1 wherein the VE is a three-dimensional VE, and wherein the functional simulation application and the VE simulation application are remote from each other and interconnected via a computer network.

8. The method of claim 7 wherein the computer network is a Local Area Network (LAN).

9. The method of claim 7 wherein the computer network is the Internet.

10. The method of claim 1 wherein the VE is a three-dimensional VE, and further comprising running a plurality of the functional simulation applications.

11. A method comprising:
interfacing a virtual environment simulation application with a functional simulation application via a runtime infrastructure (RTI) interface that communicates data between the two simulation applications according to a high level architecture (HLA) protocol.

12. A simulation system comprising:
a virtual environment (VE) simulator that is configured to (1) graphically depict a VE, (2) receive input from a user that corresponds to a user interaction with the VE, and (3) provide graphical output to the user that corresponds to a condition of the VE; and
a functional simulator that is configured to determine the condition for the VE at least in part based upon the user input;
wherein the VE simulator is configured to communicate the user input received by the VE simulation application to the functional simulation application via a high level architecture (HLA) protocol; and
wherein the functional simulator is configured to communicate the condition determined by the functional simulation application to the VE simulation application via the HLA protocol.

13. The system of claim 12 wherein the VE is a three-dimensional VE.

14. The system of claim 13 wherein the VE simulator and the functional simulator are configured to communicate with each other via a runtime infrastructure (RTI) interface.

15. The system of claim 14 wherein the VE simulator comprises an API module for communicating with the functional simulator via at least one HLA object that is defined at least in part by the received user input.

16. The system of claim 15 wherein the API module further comprises a library of HLA objects that are defined at least in part by received user input.

17. The system of claim 15 wherein the functional simulator is further configured to subscribe to the HLA object published by the API module, and wherein the functional simulator is further configured to process the subscribed HLA object through conditional logic to determine the condition for the VE.

18. The system of claim 17 wherein the functional simulator is further configured to publish an HLA object that corresponds to the determined VE condition, and wherein the API module is further configured to subscribe to the HLA object published by the functional simulation application.

19. The system of claim 18 wherein the VE simulator is further configured to determine the graphical output for the VE based on the subscribed HLA object published by the functional simulation application.

20. The system of claim 13 wherein the functional simulator and the VE simulator are remote from each other and interconnected via a computer network.

21. The system of claim 20 wherein the computer network is a Local Area Network (LAN).

22. The system of claim 20 wherein the computer network is the Internet.

23. The system of claim 12 wherein the VE is a virtual aircraft control panel.

24. An apparatus for interfacing software configured to graphically depict a three-dimensional user-interactive virtual environment (VE) with software configured to functionally simulate an application associated with the VE, the apparatus comprising:
a library of HLA objects that correspond to a state of the VE that is dependent at least in part on user interaction with the VE; and
a processor configured to (1) publish via RTI messaging at least one HLA object to the functional simulation software according to the HLA protocol, (2) subscribe via RTI messaging to at least one HLA object published by the functional simulation software according to the HLA protocol, wherein the subscribed HLA object defines at least in part a subsequent state for the VE, and (3) provide data derived from the subscribed HLA object to the VE software for processing thereby.

25. A computer readable medium for interfacing a virtual environment (VE) simulation application configured to graphically depict a three-dimensional user-interactive VE with an associated functional simulation application, the computer readable medium comprising:
a library of HLA objects that correspond to a state of the VE that is dependent at least in part on user interaction with the VE;
one or more instructions executable by a computer for publishing, via RTI messaging, at least one HLA object to the functional simulation application according to the HLA protocol;
one or more instructions executable by a computer for subscribing, via RTI messaging, to at least one HLA object published by the functional simulation application according to the HLA protocol, wherein the subscribed HLA object defines at least in part a subsequent state for the VE; and
one or more instructions executable by a computer for providing data derived from the subscribed HLA object to the VE simulation application for processing thereby.

26. An apparatus for simulating the behavior of a user-interactive environment, the apparatus comprising:
a processor configured with (1) a virtual environment (VE) simulation application for (a) graphically depicting a VE, (b) receiving input from a user that corresponds to a user interaction with the VE, and (c) providing output to the user corresponding to a condition of the VE, the condition being at least in part dependent upon the user input, (2) a functional simulation application for determining the condition of the environment at least in part based on the user input, and (3) a runtime infrastructure (RTI) interface for (a) communicating user input received by the virtual environment simulation application to the functional simulation application via a high level architecture (HLA) protocol and (b) communicating the condition determined by the functional simulation application to the virtual environment simulation application via the HLA protocol.

27. The apparatus of claim 26 wherein the RTI interface comprises an application program interface (API) module configured to receive user input from the virtual environment simulation application and publish the user input to the functional simulation application.

28. The apparatus of claim 27 further comprising a plurality of the functional simulation applications, each corresponding to a different aspect of system behavior, and wherein the RTI interface is further configured to manage communications among all of the system applications.

29. A virtual environment (VE) simulator for graphically depicting a three-dimensional user-interactive environment comprising:
a plurality of user-interactive visual objects that define at least a part of the graphical appearance of the VE;
a plurality of HLA objects that are defined at least in part by user input received by the visual objects;
an RTI interface configured to (1) publish the HLA objects to a functional simulator according to the HLA protocol for processing by the functional simulator to determine a subsequent graphical appearance for the VE and (2) subscribe to HLA objects published by the functional simulator, the subscribed HLA objects corresponding to the determined subsequent graphical appearance for the VE; and
conditional logic for determining any changes to the visual objects as a result of the subscribed HLA objects.
